(19) United States
(12) Patent Application Publication
(10) Pub. No.: US 2024/0348582 A1
(43) Pub. Date: Oct. 17, 2024

(54) SERIAL ADDRESSING FOR MULTIPLE POOL OR SPA EQUIPMENT ITEMS

(71) Applicant: Zodiac Pool Systems LLC, Carlsbad, CA (US)

(72) Inventors: Minas Minassian, Carlsbad, CA (US); Jay Robert Wherley, Asheville, NC (US)

(73) Assignee: Zodiac Pool Systems LLC, Carlsbad, CA (US)

(21) Appl. No.: 18/636,139

(22) Filed: Apr. 15, 2024

Related U.S. Application Data
(60) Provisional application No. 63/459,876, filed on Apr. 17, 2023.

(51) Int. Cl. H04L 61/5092; H04L 61/5007; H04L 61/5061

(52) U.S. Cl. CPC H04L 61/5092; H04L 61/5007; H04L 61/5061

(57) ABSTRACT

A method of self-assigning an IP address to an item of pool or spa equipment can include randomly selecting, by the item of pool or spa equipment, an IP address from a predetermined IP address range. The method can also include transmitting, by the item of pool or spa equipment, the IP address and a serial number to a target parent node. Additionally, the method can include listening, by the item of pool or spa equipment, for a broadcast topology message from the target parent node. Further, the method can include determining, by the item of pool or spa equipment, that the IP address is valid based on the broadcast topology message and, upon determining that the IP address is valid, completing a startup process by the item of pool or spa equipment.

### CROSS-REFERENCE TO RELATED APPLICATION

This application claims the benefit of U.S. Provisional Patent Application No. 63/459,876, filed on Apr. 17, 2023, and entitled “SERIAL ADDRESSING FOR MULTIPLE POOL OR SPA EQUIPMENT ITEMS,” the contents of which are hereby incorporated by reference in their entirety for all purposes.

### TECHNICAL FIELD

This disclosure relates to pool and spa networks and more particularly, although not exclusively, to systems and techniques for serially addressing equipment in a pool or spa network.

### BACKGROUND

A conventional pool automation system may include an automation controller electrically connected to multiple items of pool equipment (e.g., pumps, heaters, chlorinators, etc.). In some cases, a serial bus, such as an RS-485 bus, may rely on Serial Line Internet Protocol (SLIP) for formatting and transporting messages between the automation controller and the pool equipment items. SLIP may rely on standard TCP/IP IPv4 addresses for each item of pool equipment on the RS-485 BUS. Assignment of the IPv4 addresses in a typical home network may be accomplished using Dynamic Host Configuration Protocol (DHCP), which uses unique MAC addresses built into each piece of equipment on the home network. At the RS-485 BUS using SLIP, neither the DHCP nor MAC addresses are available for use in addressing the pool equipment items.

Accordingly, a new way of assigning IP addresses, which is not reliant upon human-entered values, is desired. Removing human interactions from the equation may provide greater addressing efficiency and may prevent addressing errors or inaccuracies. Human inefficiencies, errors, and inaccuracies may all result in performance problems including communication speed delays and errors.

### SUMMARY

Serial addressing systems and techniques can be provided to establish communication pathways between equipment in a pool or spa network. For example, a method of self-assigning an IP address to an item of pool or spa equipment described herein can include randomly selecting, by the item of pool or spa equipment, an IP address from a predetermined IP address range. The method can also include transmitting, by the item of pool or spa equipment, the IP address and a serial number to a target parent node. Additionally, the method can include listening, by the item of pool or spa equipment, for a broadcast topology message from the target parent node. Further, the method can include determining, by the item of pool or spa equipment, that the IP address is valid based on the broadcast topology message and, upon determining that the IP address is valid, completing a startup process by the item of pool or spa equipment.

In an additional example, a method can include determining, by an item of pool or spa equipment, an IP address from a globally unique serial number. The method may also include transmitting, by the item of pool or spa equipment, the IP address and the globally unique serial number to a target parent node. Additionally, the method may include listening, by the item of pool or spa equipment, for a broadcast topology message from the target parent node. Further, the method may include determining, by the item of pool or spa equipment, that the IP address is valid based on the broadcast topology message and, upon determining that the IP address is valid, completing a startup process by the item of pool or spa equipment.

In an additional example, a system may include a processor and a non-transitory computer-readable storage medium comprising instructions that are executable by the processor to perform operations. The operations can include determining, by an item of pool or spa equipment, an IP address from a globally unique serial number. The operations can also include transmitting, by the item of pool or spa equipment, the IP address and the globally unique serial number to a target parent node and listening, by the item of pool or spa equipment, for a broadcast topology message from the target parent node. Further, the operations can include determining, by the item of pool or spa equipment, that the IP address is invalid based on the broadcast topology message. Furthermore, the operations can include randomly selecting, by the item of pool or spa equipment, an updated IP address from a predetermined IP address range and transmitting, by the item of pool or spa equipment, the updated IP address and the globally unique serial number to the target parent node. Moreover, the operations can include listening, by the item of pool or spa equipment, for an updated broadcast topology message from the target parent node and determining, by the item of pool or spa equipment, that the IP address is valid based on the updated broadcast topology message. Upon determining that the IP address is valid, the operations can include completing a startup process by the item of pool or spa equipment.

### BRIEF DESCRIPTION OF THE DRAWINGS

Features, embodiments, and advantages of the present disclosure are better understood when the following Detailed Description is read with reference to the accompanying drawings.

FIG. 1 is a schematic diagram of a communication network illustrating an implementation of an RS-485 bus according to certain aspects of the present disclosure.

FIG. 2 is a schematic diagram of a plurality of example network topologies according to certain aspects of the present disclosure.

FIG. 3 is a schematic diagram of a pool or spa network according to certain aspects of the present disclosure.

FIG. 4 is a flow chart of a process for addressing an agent node according to certain aspects of the present disclosure.

FIG. 5 is a flow chart of an additional process for addressing an agent node according to certain aspects of the present disclosure.

FIG. 6 is a schematic diagram of components of a computer system according to certain aspects of the present disclosure.

### DETAILED DESCRIPTION

Examples described herein relate to systems, devices, and techniques for serially addressing equipment in a pool or spa network of a pool or spa system (referred to herein as “pool or spa system” or just a “pool system”). The network may use a communication bus, such as an RS-485, to enable communications between a pool automation controller and various items of connected equipment. Providing communication addresses to the connected equipment may be used to accurately address communications between the pool automation controller and the various items of connected equipment. The techniques described herein relate to a process for automatically identifying the addresses of disconnected equipment and, once identified, automatically joining the disconnected equipment to the network of connected equipment of the pool system. Generally, the process may be performed using randomized self-addressing or serial number derived self-addressing, as discussed in greater detail below.

A pool automation system used in connection with the techniques described herein may include an automation controller and any suitable number of connected equipment items (which may also include connected devices). The automation controller may be a computer system that functions as the brain of the pool automation system. Thus, the automation controller may include a processor, memory, interfaces, display, I/O capabilities, and any other suitable computing component to enable the techniques described herein. Via digital interfaces of the automation controller, the automation controller may send and/or receive signals to and/or from the connected equipment. The interfaces, which may be wired or wireless, may enable two-way communications. For example, the automation controller may send control signals to the connected equipment (e.g., turn on, turn off, run a sequence, etc.), and the connected equipment may return information to the automation controller (e.g., state information, diagnostic information, etc.).

The automation controller may also enable connections with user devices, other user interfaces, and the like. For example, the automation controller may include a network interface for communicating with a user device via a Bluetooth connection and/or via a local area network such as WiFi. In some examples, the network interfaces may include and/or support cellular connectivity. In some examples, the automation controller may be local to the pool system (e.g., positioned within a physical proximity of the pool system) or the automation controller may be a cloud-based controller that communicates with equipment in the pool system through the Internet. In additional examples, the automation controller may be a distributed computing system where portions of the automation controller are local and other portions are cloud-based.

The connected equipment items may include mechanical equipment such as pumps, heaters, cleaners, lights, covers, valves, skimmers, filters, chlorinators, pH systems, etc. In some examples, at least some of the mechanical equipment may be powered/controlled via relays, while other equipment may be considered “smart” equipment that supports at least some communication with the automation controller via digital connections. For example, these digital connections may be made using communication bus systems such as RS-485, Controller Area Network (CAN) bus, and other balanced bus systems.

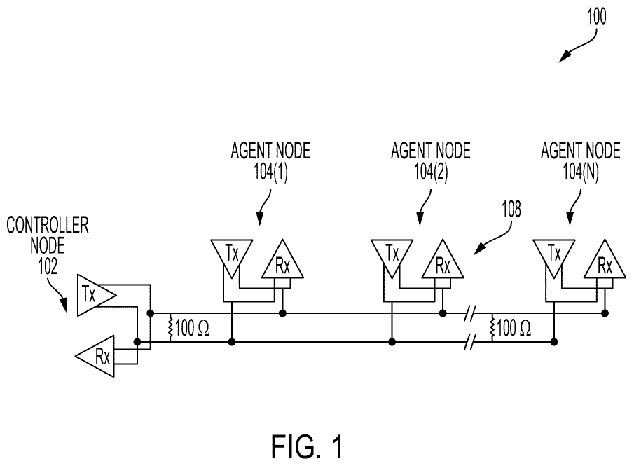

Turning now to the figures, FIG. 1 illustrates communication network 100 illustrating an implementation of an RS-485 bus 108, according to at least one example. The communication network 100 may include a controller node 102 electrically connected via the RS-485 bus 108 to a plurality of agent nodes 104(1), 104(2), 104(n). The controller node 102 is an example of an automated controller described herein. The agent nodes 104 are examples of the connected pool or spa equipment items described herein. As noted, the communication network 100 may include any suitable number of agent nodes 104, including more or fewer than illustrated. The communication network 100 may represent a linear bus topology, extending between the controller node 102 and the agent node 104(n).

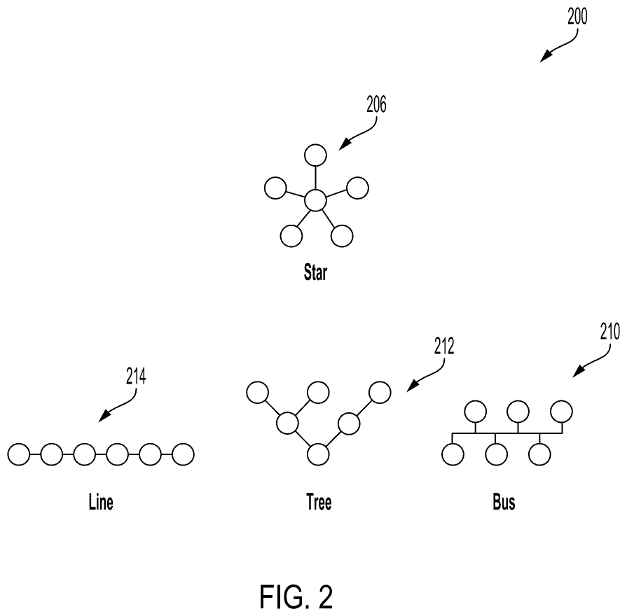

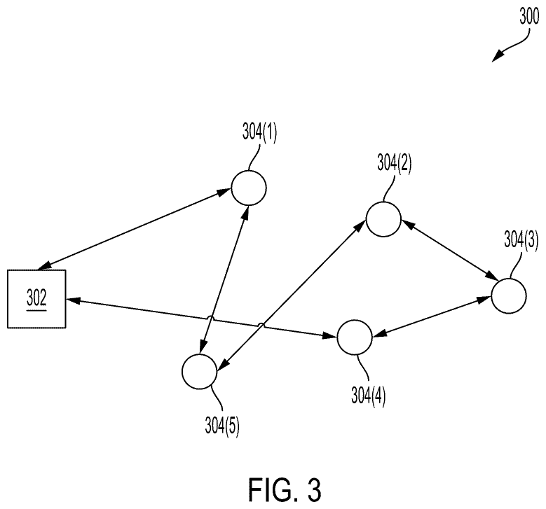

FIG. 2 illustrates a diagram 200 depicting a plurality of example network topologies 206-214, which may be used in connection with the techniques for network addressing described herein, according to at least some examples. Each of the network topologies 206-214 may include a controller node and a plurality of agent nodes. The techniques described herein may be suitable for identifying network addresses for the plurality of agent nodes. This may be performed regardless of the specific network topology or where the controller node is placed with respect to the topology. In other words, the controller node, for each network topology 206-214, may be any one of the respective nodes. The network topologies 206-214 may represent example topologies that may be created as installers set up a pool or spa system. For example, the specific constraints of the environment in which the system is installed may use a particular topology. Similarly, changes to the system over time may change the topology. In some examples, the topology of a particular pool or spa system may correspond to a combination of topologies referenced herein. For example, a topology may begin as a bus topology 210, but a later node may be connected directly to an existing node connected to the bus. This can lead to topologies of arbitrary design and layout. For example, FIG. 3 illustrates such a topology.

In particular, FIG. 3 illustrates a pool or spa network 300 including a controller node 302 (e.g., an automation controller or other parent node) and a plurality of agent nodes 304(1)-304(5) (e.g., pool or spa equipment), according to at least one example. The pool network 300 is an example of the communication network 100 in that the plurality of agent nodes 304 may communicate with controller node 302 via a communication bus such as an RS-485 (e.g., represented by the connecting lines between the nodes).

In some examples, the agent nodes 304 may join the network of the controller node 302 using randomized self-addressing or serial number self-addressing. In an IPv4 network, link-local addresses in the range of 169.254.1.0 to 169.254.254.255 are reserved for communication within a subnetwork to which a host (e.g., the controller node 302) is connected. This range of addresses may avoid any possible conflict with other network interfaces on the controller node 302 that could potentially use private network addressing (e.g., 192.168.x.x and 10.x.x.x) by way of homeowner configured WiFi/networks. These addresses may not be visible to the outside world or the Internet, and the addresses are not directly routable to or from the pool or spa network 300. Even with reserving a selection of available addresses in this range for broadcast and core node use, more than 65,000 possible addresses may be available for each agent node 304 in a particular pool system. The addresses rely on uniqueness within the pool or spa network 300 and not global uniqueness. Accordingly, the more than 65,000 possible addresses are more than sufficient for providing uniqueness within the pool or spa network 300 with minimal opportunity for an incidental overlap among the devices within the pool or spa network 300.

Each agent node 304, at power up, may randomly choose an IP address out of the more than 65,000 possible addresses in the 169.254.1.0-169.254.254.255 address space. The agent node 304 may begin periodically broadcasting (e.g., sending to 169.254.255.255) a message indicating the IP address it randomly selected and including a globally unique serial number of the agent node 304. The controller node 302, upon hearing a broadcast from the agent node 304, may store the randomly selected IP address for the agent node 304. The controller node 302 may periodically broadcast a topology message containing the valid IP address and serial number pairs the controller node 302 has received and recorded to confirm the IP address assignment for the agent node 304. When the agent device 304 identifies its serial number in the topology message, the agent node 304 will continue a startup process with the understanding that the randomly selected IP address is valid and known to the controller node 302. The agent node 304 can proceed to establish a TCP/IP connection over the SLIP link with the controller node 302 and transport TCP/IP framed messages.

In some examples, the controller node 302 may also periodically broadcast a discovery message requesting IP addresses from all unregistered agent nodes 304. In such an example, the agent node may respond by sending a message indicating the IP address it randomly selected and including a globally unique serial number of the agent node 304. The controller node 302, upon receiving the response from the agent node 304, may store the randomly selected IP address for the agent node 304. The controller node 302 may periodically broadcast a topology message containing the valid IP address and serial number pairs the controller node 302 has received and recorded to confirm the IP address assignment for the agent node 304. When the agent device 304 identifies its serial number in the topology message, the agent node 304 will continue a startup process with the understanding that the randomly selected IP address is valid and known to the controller node 302. The agent node 304 can proceed to establish a TCP/IP connection over the SLIP link with the controller node 302 and transport TCP/IP framed messages.

In a very rare occurrence, the controller node 302 can flag that colliding address choices have occurred among more than one agent node 304. The flag by the controller node 302 can include providing a flag in the topology message indicating that one or more agent nodes 304 should randomly select a new IP address.

In an additional example, each agent node 304 may use its alphanumeric serial number of each agent node 304 to self-derive an IP address. As there may be at least 31 bits of unique information in the serial number, and as there are only around 16 bits of assignable address values in the 169.254.1.0-169.254.254.255 space, there remains a chance of IP address collision. Accordingly, the controller node 302 can flag that colliding address choices have occurred among more than one agent node 304. The flag by the controller node 302 can include providing a flag in the topology message indicating that one or more agent nodes 304 should randomly select a new IP address. In other words, a first option may be to establish the IP address based on the alphanumeric serial number of the agent node 304. If an address collision occurs, then the agent node 304 can randomly select an alternative IP address.

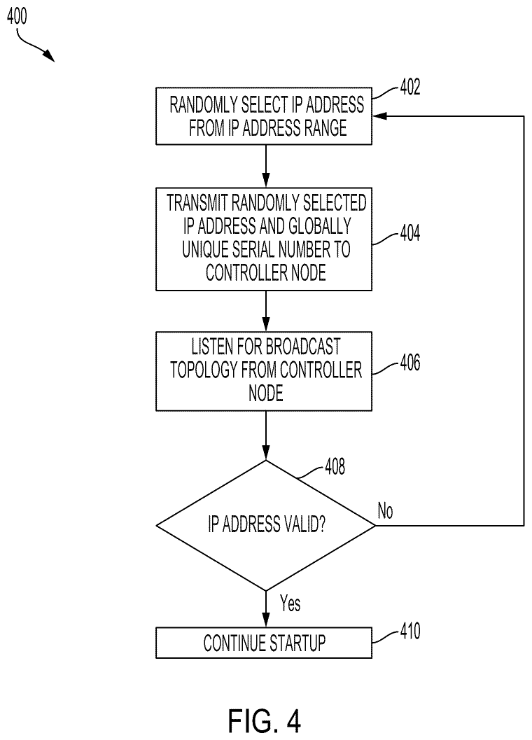

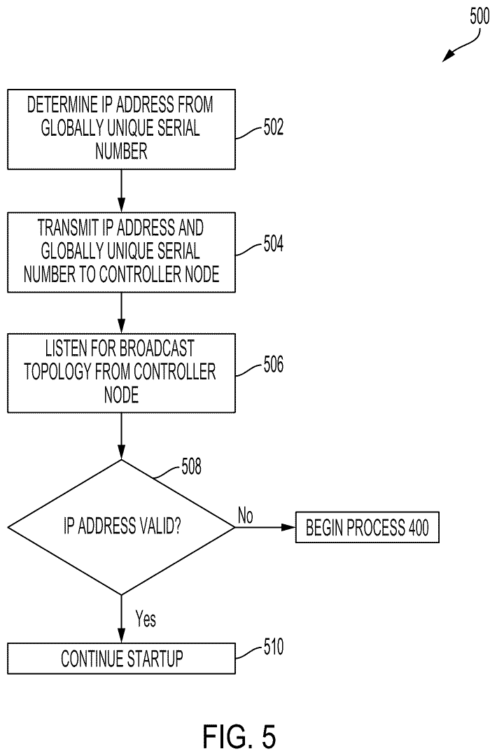

FIGS. 4 and 5 illustrate example flow diagrams showing process 400 and process 500, respectively, according to at least two examples. These processes, and any other processes described herein, are illustrated as logical flow diagrams, each operation of which represents a sequence of operations that can be implemented in hardware, computer instructions, or a combination thereof. In the context of computer instructions, the operations may represent computer-executable instructions stored on one or more non-transitory computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, some, any, or all of the processes described herein may be performed under the control of one or more computer systems configured with specific executable instructions and may be implemented as code (e.g., executable instructions, one or more computer programs, or one or more applications) executing collectively on one or more processors, by hardware, or combinations thereof. As noted above, the code may be stored on a non-transitory computer-readable storage medium, for example, in the form of a computer program including a plurality of instructions executable by one or more processors.

FIG. 4 illustrates a flow chart depicting the example process 400 for addressing an agent node 304, according to at least one example. The process 400 is performed by the agent node 304 (e.g., a processor of pool or spa equipment of a pool or spa system deployed within the pool or spa network such as the network 300).

At block 402, the process 400 involves the agent node 304 randomly selecting an IP address from a predetermined IP address range during startup of the agent node 304. This may include an IPv4 network address in the range of 169.254.1.0 to 169.254.254.255. These addresses may not be visible to the outside world or the Internet, and the addresses are not directly routable to or from the pool or spa network 300. Even with reserving a selection of available addresses in this range for broadcast and core node use, more than 65,000 possible addresses may be available for each agent node 304 in a particular pool system. The addresses rely on uniqueness within the pool or spa network 300 and not global uniqueness.

At block 404, the process 400 involves the agent node 304 transmitting the randomly selected IP address and a globally unique serial number of the agent node 304 to the controller node 302. The globally unique serial number may be an alphanumeric number unique to the particular agent node 304. The serial number may be used by the controller node 302 to identify the particular agent node 304 in a broadcast topology message from the controller node 302 to a set of agent nodes 304.

At block 406, the process 400 involves the agent node 304 listening for the broadcast topology message from the controller node 302. The broadcast topology message may include an indication of sets of valid IP address and serial number pairs. The valid IP address and serial number pairs may be an indication of agent nodes that have established a valid IP address with the controller node 302.

At block 408, the process 400 involves determining, by the agent node 304, if the randomly selected IP address for the agent node 304 is valid. The IP address is determined to be valid if the agent node 304 identifies itself within the broadcast topology message. That is, the agent node 304 may review the broadcast topology message to locate the IP address and serial number pair that was transmitted at block 404.

If the IP address is valid, then, at block 410, the process 400 involves the agent node 304 continuing the startup process with the understanding that the agent node 304 has a valid IP address for communicating with the controller node 302. Upon completion of the startup process, the agent node 304 may interact with the controller node 302 using two-way communication. If the IP address is not valid, then the process 400 restarts at block 402 for random selection by the agent node 304 of a new IP address from the predetermined IP address range.

FIG. 5 illustrates a flow chart depicting an additional example process 500 for addressing an agent node 304, according to at least one example. The process 500 is performed by the agent node 304 (e.g., a processor of pool or spa equipment of a pool or spa system deployed within the pool or spa network such as the network 300).

At block 502, the process 500 involves the agent node 304 determining an IP address from a globally unique serial number of the agent node 304. This may include an IPV4 network address in the range of 169.254.1.0 to 169.254.254.255, which is determined by the converting the bits of at least a portion of the serial number into numbers of the IP address.

At block 504, the process 500 involves the agent node 304 transmitting the determined IP address and the globally unique serial number of the agent node 304 to the controller node 302. The globally unique serial number may be an alphanumeric number unique to the particular agent node 304. The serial number may be used by the controller node 302 to identify the particular agent node 304 in a broadcast topology message from the controller node 302 to a set of agent nodes 304.

At block 506, the process 500 involves the agent node 304 listening for the broadcast topology message from the controller node 302. The broadcast topology message may include an indication of sets of valid IP address and serial number pairs. The valid IP address and serial number pairs may be an indication of agent nodes that have established a valid IP address with the controller node 302.

At block 508, the process 500 involves determining, by the agent node 302, if the determined IP address for the agent node 304 is valid. The IP address is determined to be valid if the agent node 304 identifies itself within the broadcast topology message. That is, the agent node 304 may review the broadcast topology message to locate the IP address and serial number pair that was transmitted at block 504.

If the IP address is valid, then, at block 510, the process 500 involves the agent node 304 continuing the startup process with the understanding that the agent node 304 has a valid IP address for communicating with the controller node 302. Upon completion of the startup process, the agent node 304 may interact with the controller node 302 using two-way communication. If the IP address is not valid, then the process 400 from FIG. 4 begins at block 402 through a random selection by the agent node 304 of a new IP address from the predetermined IP address range.

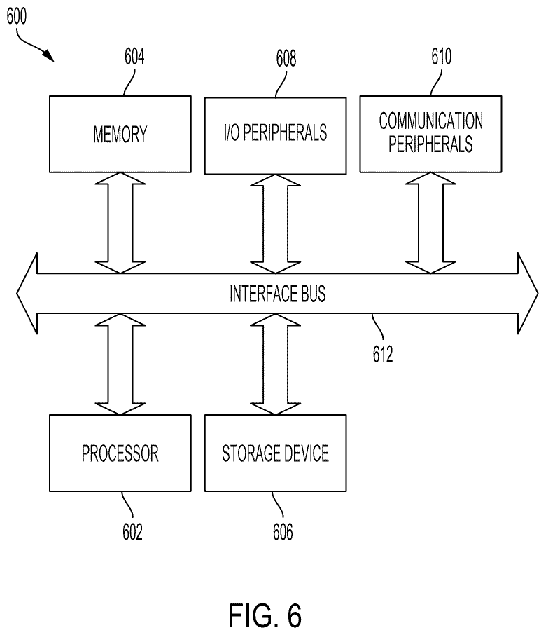

FIG. 6 illustrates examples of components of a computer system 600, according to at least one example. The computer system 600 is an example of controllers and/or microcontrollers of pool equipment and/or pool automation systems including automation controllers, and the like.

The computer system 600 may include at least a processor 602, a memory 604, a storage device 606, input/output peripherals (I/O) 608, communication peripherals 610, and an interface bus 612. The interface bus 612 is configured to communicate, transmit, and transfer data, controls, and commands among the various components of the computer system 600. The memory 604 and the storage device 606 include computer-readable storage media, such as Radom Access Memory (RAM), Read ROM, electrically erasable programmable read-only memory (EEPROM), hard drives, CD-ROMs, optical storage devices, magnetic storage devices, electronic non-volatile computer storage, for example Flash® memory, and other tangible storage media. Any of such computer-readable storage media can be configured to store instructions or program codes embodying aspects of the disclosure. The memory 604 and the storage device 606 also include computer-readable signal media. A computer-readable signal medium includes a propagated data signal with computer-readable program code embodied therein. Such a propagated signal takes any of a variety of forms including, but not limited to, electromagnetic, optical, or any combination thereof. A computer-readable signal medium includes any computer-readable medium that is not a computer-readable storage medium and that can communicate, propagate, or transport a program for use in connection with the computer system 600.

Further, the memory 604 may include an operating system, programs, and applications. The processor 602 is configured to execute the stored instructions and includes, for example, a logical processing unit, a microprocessor, a digital signal processor, and other processors. The memory 604 and/or the processor 602 can be virtualized and can be hosted within another computing system of, for example, a cloud network or a data center. The I/O peripherals 608 may include user interfaces, such as a keyboard, screen (e.g., a touch screen), microphone, speaker, other input/output devices, and computing components, such as graphical processing units, serial ports, parallel ports, universal serial buses, and other input/output peripherals. The I/O peripherals 608 are connected to the processor 602 through any of the ports coupled to the interface bus 612. The communication peripherals 610 are configured to facilitate communication between the computer system 600 and other computing devices over a communications network and include, for example, a network interface controller, modem, wireless and wired interface cards, antenna, and other communication peripherals.

A collection of exemplary embodiments, including at least some explicitly enumerated as “Examples” providing additional description of a variety of example types in accordance with the concepts described herein are provided below. These examples are not meant to be mutually exclusive, exhaustive, or restrictive; and are not limited to these examples but rather encompasses all possible modifications and variations within the scope of the issued claims and their equivalents.
A. A method of self-assigning an IP address to a item of pool or spa equipment, the method comprising: i) randomly selecting, by the item of pool or spa equipment, an IP address from a predetermined IP address range, ii) transmitting, by the item of pool or spa equipment, the IP address and a serial number to a target parent node, iii) listening, by the item of pool or spa equipment, for a broadcast topology message from the target parent node, iv) determining, by the item of pool or spa equipment, that the IP address is valid based on the broadcast topology message, and v) upon determining that the IP address is valid, completing a startup process by the item of pool or spa equipment.
B. A method of self-assigning an IP address to a item of pool or spa equipment, the method comprising: i) determining, by the item of pool or spa equipment, an IP address from a globally unique serial number, ii) transmitting, by the item of pool or spa equipment, the IP address and the globally unique serial number to a target parent node target, iii) listening, by the item of pool or spa equipment, for a broadcast topology message from the target parent node, iv) determining, by the item of pool or spa equipment, that the IP address is valid based on the broadcast topology message, and v) upon determining that the IP address is valid, completing a startup process by the item of pool or spa equipment.
C. An item of pool or spa equipment configured to randomly select and validate an IP address with a controller of a pool or spa system, where validation of the IP address enables the item of pool or spa equipment to join a pool or spa equipment network associated with the controller.
D. An item of pool or spa equipment configured to self-determine and validate an IP address with a controller of a pool or spa system, wherein validation of the IP address enables the item of pool or spa equipment to join a pool or spa equipment network associated with the controller, and wherein the IP address is determinable based on a globally unique serial number of the item of pool or spa equipment.
E. A method of self-assigning an IP address to an item of pool or spa equipment, the method comprising: randomly selecting, by the item of pool or spa equipment, an IP address from a predetermined IP address range; transmitting, by the item of pool or spa equipment, the IP address and a serial number to a target parent node; listening, by the item of pool or spa equipment, for a broadcast topology message from the target parent node; determining, by the item of pool or spa equipment, that the IP address is valid based on the broadcast topology message; and upon determining that the IP address is valid, completing a startup process by the item of pool or spa equipment.
F. The method of any of the preceding or subsequent examples or combination of examples.
G. The method of example E, wherein the IP address comprises an IPv4 network address, and wherein the predetermined IP address range comprises a set of link-local addresses from 169.254.1.0 to 169.254.254.255.
H. The method of example E, wherein the target parent node comprises an automation controller of the pool or spa equipment.
I. The method of example E, wherein completing the startup process comprises establishing two-way communication between the item of pool or spa equipment and the target parent node.
J. The method of example I, wherein messages communicated in the two-way communication are formatted and transported using Serial Line Internet Protocol (SLIP).
K. The method of example E, wherein the broadcast topology message from the target parent node comprises an indication of valid IP address and serial number pairs of a set of items of pool or spa equipment.
L. The method of example E, wherein the item of pool or spa equipment is selected from the group consisting of a pump, a heater, a cleaner, a light, a cover, a valve, a skimmer, a filter, a chlorinator, and a pH system.
M. The method of example E, further comprising: receiving, by the item of pool or spa equipment, a discovery message from the target parent node requesting IP addresses from all unregistered items of pool or spa equipment, wherein the IP address is randomly selected by the item of pool or spa equipment in response to receiving the discovery message.
N. A method comprising: determining, by an item of pool or spa equipment, an IP address from a globally unique serial number; transmitting, by the item of pool or spa equipment, the IP address and the globally unique serial number to a target parent node; listening, by the item of pool or spa equipment, for a broadcast topology message from the target parent node; determining, by the item of pool or spa equipment, that the IP address is valid based on the broadcast topology message; and upon determining that the IP address is valid, completing a startup process by the item of pool or spa equipment.
O. The method of example N, wherein the IP address comprises an IPv4 network address, and wherein the IP address is generated from a range of link-local addresses from 169.254.1.0 to 169.254.254.255.

P. The method of example N, wherein completing the startup process comprises establishing two-way communication between the item of pool or spa equipment and the target parent node.
Q. The method of example P, wherein messages communicated in the two-way communication are formatted and transported using Serial Line Internet Protocol (SLIP).
R. The method of example N, wherein the broadcast topology message from the target parent node comprises an indication of valid IP address and serial number pairs of a set of items of pool or spa equipment.
S. The method of example N, wherein the item of pool or spa equipment is selected from the group consisting of a pump, a heater, a cleaner, a light, a cover, a valve, a skimmer, a filter, a chlorinator, and a pH system.
T. The method of example N, further comprising: receiving, by the item of pool or spa equipment, a discovery message from the target parent node requesting IP addresses from all unregistered items of pool or spa equipment, wherein the IP address is randomly selected by the item of pool or spa equipment in response to receiving the discovery message.
U. A system comprising: a processor; and a non-transitory computer-readable storage medium comprising instructions that are executable by the processor to perform operations comprising: determining, by an item of pool or spa equipment, an IP address from a globally unique serial number; transmitting, by the item of pool or spa equipment, the IP address and the globally unique serial number to a target parent node; listening, by the item of pool or spa equipment, for a broadcast topology message from the target parent node; determining, by the item of pool or spa equipment, that the IP address is invalid based on the broadcast topology message; randomly selecting, by the item of pool or spa equipment, an updated IP address from a predetermined IP address range; transmitting, by the item of pool or spa equipment, the updated IP address and the globally unique serial number to the target parent node; listening, by the item of pool or spa equipment, for an updated broadcast topology message from the target parent node; determining, by the item of pool or spa equipment, that the IP address is valid based on the updated broadcast topology message; and upon determining that the IP address is valid, completing a startup process by the item of pool or spa equipment.
V. The system of example U, wherein the updated IP address comprises an IPv4 network address, and wherein the predetermined IP address range comprises a set of link-local addresses from 169.254.1.0 to 169.254.254.255.
W. The system of example U, wherein completing the startup process comprises establishing two-way communication between the item of pool or spa equipment and the target parent node.
X. The system of example W, wherein messages communicated in the two-way communication are formatted and transported using Serial Line Internet Protocol (SLIP).
Y. The system of example U, wherein the broadcast topology message and the updated broadcast topology message from the target parent node comprise indications of valid IP address and serial number pairs of a set of items of pool or spa equipment.

For avoidance of doubt, any combination of features not physically impossible or expressly identified as non-combinable herein may be within the scope of the described embodiments. Further, although applicant has described devices and techniques for use principally with automated controllers, persons skilled in the relevant field will recognize that the present disclosure conceivably could be employed in connection with other objects and in other manners. Finally, references to “pools” and “swimming pools” herein may also refer to spas or other water containing vessels used for recreation or therapy and for which control is needed or desired.

What is claimed is:

1. A method of self-assigning an IP address to an item of pool or spa equipment, the method comprising:
randomly selecting, by the item of pool or spa equipment, an IP address from a predetermined IP address range;
transmitting, by the item of pool or spa equipment, the IP address and a serial number to a target parent node;
listening, by the item of pool or spa equipment, for a broadcast topology message from the target parent node;
determining, by the item of pool or spa equipment, that the IP address is valid based on the broadcast topology message; and
upon determining that the IP address is valid, completing a startup process by the item of pool or spa equipment.

2. The method of claim 1, wherein the IP address comprises an IPv4 network address, and wherein the predetermined IP address range comprises a set of link-local addresses from 169.254.1.0 to 169.254.254.255.

3. The method of claim 1, wherein the target parent node comprises an automation controller of the pool or spa equipment.

4. The method of claim 1, wherein completing the startup process comprises establishing two-way communication between the item of pool or spa equipment and the target parent node.

5. The method of claim 4, wherein messages communicated in the two-way communication are formatted and transported using Serial Line Internet Protocol (SLIP).

6. The method of claim 1, wherein the broadcast topology message from the target parent node comprises an indication of valid IP address and serial number pairs of a set of items of pool or spa equipment.

7. The method of claim 1, wherein the item of pool or spa equipment is selected from the group consisting of a pump, a heater, a cleaner, a light, a cover, a valve, a skimmer, a filter, a chlorinator, and a pH system.

8. The method of claim 1, further comprising:
receiving, by the item of pool or spa equipment, a discovery message from the target parent node requesting IP addresses from all unregistered items of pool or spa equipment, wherein the IP address is randomly selected by the item of pool or spa equipment in response to receiving the discovery message.

9. A method comprising:
determining, by an item of pool or spa equipment, an IP address from a globally unique serial number;
transmitting, by the item of pool or spa equipment, the IP address and the globally unique serial number to a target parent node;
listening, by the item of pool or spa equipment, for a broadcast topology message from the target parent node;
determining, by the item of pool or spa equipment, that the IP address is valid based on the broadcast topology message; and
upon determining that the IP address is valid, completing a startup process by the item of pool or spa equipment.

10. The method of claim 9, wherein the IP address comprises an IPV4 network address, and wherein the IP address is generated from a range of link-local addresses from 169.254.1.0 to 169.254.254.255.

11. The method of claim 9, wherein completing the startup process comprises establishing two-way communication between the item of pool or spa equipment and the target parent node.

12. The method of claim 11, wherein messages communicated in the two-way communication are formatted and transported using Serial Line Internet Protocol (SLIP).

13. The method of claim 9, wherein the broadcast topology message from the target parent node comprises an indication of valid IP address and serial number pairs of a set of items of pool or spa equipment.

14. The method of claim 9, wherein the item of pool or spa equipment is selected from the group consisting of a pump, a heater, a cleaner, a light, a cover, a valve, a skimmer, a filter, a chlorinator, and a pH system.

15. The method of claim 9, further comprising:
receiving, by the item of pool or spa equipment, a discovery message from the target parent node requesting IP addresses from all unregistered items of pool or spa equipment, wherein the IP address is randomly selected by the item of pool or spa equipment in response to receiving the discovery message.

16. A system comprising:
a processor; and
a non-transitory computer-readable storage medium comprising instructions that are executable by the processor to perform operations comprising:
determining, by an item of pool or spa equipment, an IP address from a globally unique serial number;
transmitting, by the item of pool or spa equipment, the IP address and the globally unique serial number to a target parent node;
listening, by the item of pool or spa equipment, for a broadcast topology message from the target parent node;
determining, by the item of pool or spa equipment, that the IP address is invalid based on the broadcast topology message;
randomly selecting, by the item of pool or spa equipment, an updated IP address from a predetermined IP address range;
transmitting, by the item of pool or spa equipment, the updated IP address and the globally unique serial number to the target parent node;
listening, by the item of pool or spa equipment, for an updated broadcast topology message from the target parent node;
determining, by the item of pool or spa equipment, that the IP address is valid based on the updated broadcast topology message; and
upon determining that the IP address is valid, completing a startup process by the item of pool or spa equipment.

17. The system of claim 16, wherein the updated IP address comprises an IPv4 network address, and wherein the predetermined IP address range comprises a set of link-local addresses from 169.254.1.0 to 169.254.254.255.

18. The system of claim 16, wherein completing the startup process comprises establishing two-way communication between the item of pool or spa equipment and the target parent node.

19. The system of claim 18, wherein messages communicated in the two-way communication are formatted and transported using Serial Line Internet Protocol (SLIP).

20. The system of claim 16, wherein the broadcast topology message and the updated broadcast topology message from the target parent node comprise indications of valid IP address and serial number pairs of a set of items of pool or spa equipment.
